(19) United States
(12) Patent Application Publication
(10) Pub. No.: US 2011/0053112 A1
(43) Pub. Date: Mar. 3, 2011

(54) DRILL WITH BANDED MARKINGS

(76) Inventor: Bernard Weissman, New York, NY (US)

(21) Appl. No.: 12/553,360

(22) Filed: Sep. 3, 2009

(51) Int. Cl. A61C 3/02

(52) U.S. Cl. 433/165

(57) ABSTRACT

A dental drill is used for preparing an osteotomy and includes a socket operably received in a hand piece; a shaft for cutting the osteotomy. The shaft has a tip end and bands that have a first and second edge. The second edge is further from the tip end than the first edge. The edges mark an osteotomy depth from a bone or a surgical length from a gingivus.

### BACKGROUND OF THE INVENTION

1. Field of the Invention

The present invention relates to improvements in drills used for implant dentistry.

2. Discussion of the Related Art

In implant dentistry, a replacement tooth is permanently secured to a patient's mandibular or maxilla bone by taking advantage of the body's ability to osseointegrate certain materials. The replacement tooth comprises an implant, typically made of Titanium, which is socketed into an opening, i.e., osteotomy, which has been previously prepared by a dentist in the patient's mandible or maxilla, i.e., implant site. In due course, the natural bone adheres to the implant. After a certain period, a physiologically correct crown is secured to the protruding implant to create a stump for a crown alike a natural tooth.

Implants are typically provided in a system and differ by embedment length that is received in the osteotomy and by the diameter of the implant. Thus, an appropriately sized implant can be selected for each site. Consequently, implants must be installed in an osteotomy that has been prepared to specific depths, for example, by drilling to a depth, according to the implant manufacturer's specification. When the osteotomy is not prepared to the proper depth, the implant may be incorrectly installed causing the prosthetic tooth to be irregularly aligned. Since the preferred location is to place the implant head directly onto the crest of the bone, e.g., the implant head is situated on the crestal bone, the depth is measured from the crest.

Dentists may differ on the best way to prepare the osteotomy. In the flap surgical procedure, the mucosa over the proposed implant site is cut and inflected, i.e., laid back, to expose the underlying bone. An osteotomy is then prepared measuring the depth from the bone.

Other dentists believe that making extensive cuts to prepare gingival flaps is unnecessarily painful for a patient and prolongs the healing process. Instead, a flapless surgical procedure is used.

In one type of flapless surgical procedure, a portion of the gingiva, which is slightly larger than the drill, is punched out so that the drill does not lacerate the gingival. The osteotomy then is prepared through the punch-out. Now a preferred, less invasive flapless procedure uses a needlepoint drill to drill through the mucosa by spreading the tissue without injuring the tissue.

Therein, the osteotomy depth is the same as in the flap procedure for the same implant, but now the dentist must also determine the thickness of the gingiva. Since the punch-out is relatively small and the drill and obstructs the dentist's view of the bone or, in the most recent type, the needlepoint drill provides no viewable bones surface, the dentists must guess at the proper length of drill to utilize, i.e., the surgical length. Typically, dentists estimate the gingival thickness, adjusting the approximate osteotomy depths. However, the flapless procedures require dentists to progressively remove the drill in order to verify its depth.

Indeed, both flap and flapless procedures are used depending on patients' implant site and health conditions. The flap procedures, however, must be used to expose and prepare the bone where grafted bone or synthetic bone substances are used to rebuild the bone level.

Thus, what is needed is one drill for preparing osteotomies to a predetermined precise depth in the selective use of the flap and flapless procedure.

### SUMMARY OF THE INVENTION

These and other needs are met by the present invention. Therein, a dental drill is used for preparing an osteotomy and includes a socket operably received in a hand piece; a shaft for cutting the osteotomy. The shaft has a tip end bands that have a first and second edge. The second edge is further from the tip end than the first edge. The edges mark an osteotomy depth from a bone or from a gingivus. Moreover, each 3 mm band is used to indent the osteotomy to the selected needs. The first edge is used with flap tissue deflected procedures and the second edge is used for flapless procedures.

### BRIEF DESCRIPTION OF THE DRAWINGS

FIG. 1 is a side view of a drill in accordance with one or more embodiments of the present invention.

FIG. 2 is a detailed view of the drill of FIG. 1, wherein the bands are shown.

FIG. 3a is a cross-sectional view of a drill in an osteotomy wherein a flap has been created.

FIG. 3b is a cross-sectional view of a drill in an osteotomy used with a punch-out at the gingiva.

FIG. 4 is a detailed view of the drill of FIG. 1, wherein the bands are shown having a particular gradation coloration.

### DETAILED DESCRIPTION OF THE INVENTION

Reference will now be made in detail to several views of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

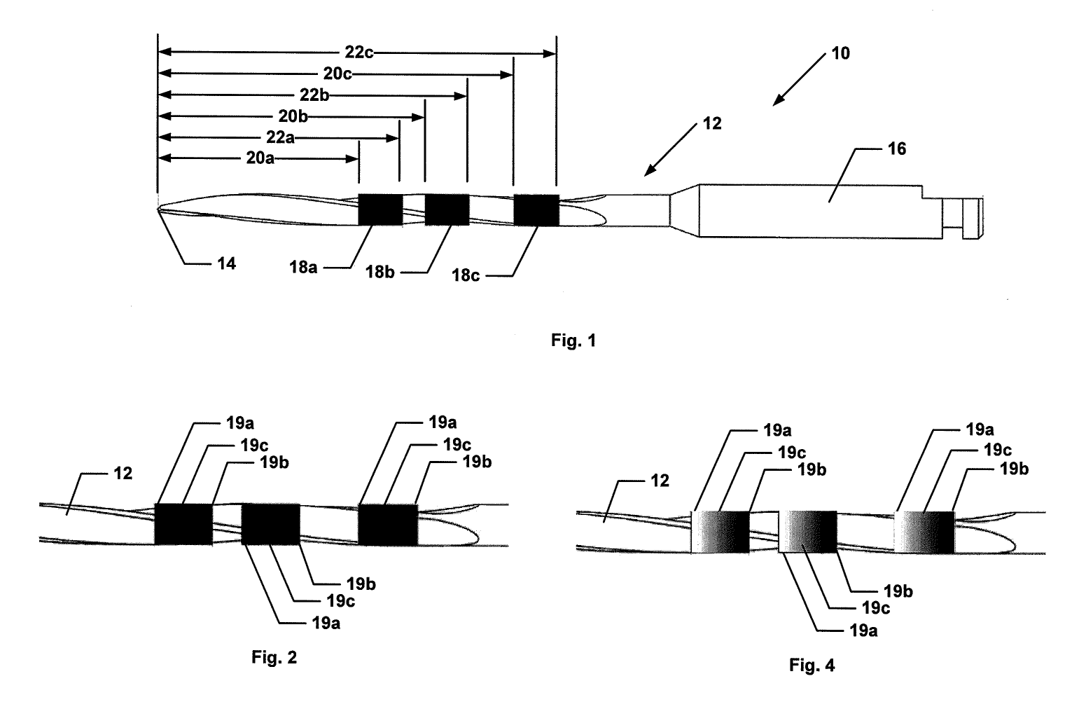

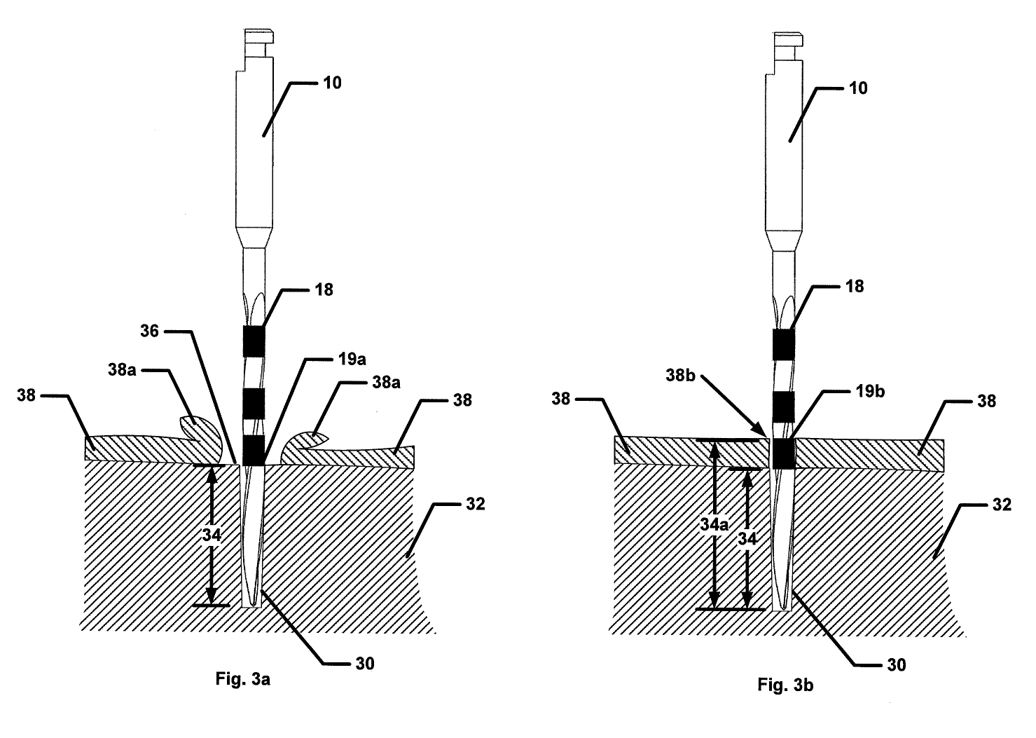

FIG. 1 is a side view of a drill in accordance with one or more embodiments of the present invention. FIG. 2 is a detailed view of the drill of FIG. 1, wherein the bands are shown. FIG. 3a is a cross-sectional view of a drill in an osteotomy wherein a flap has been created. FIG. 3b is a cross-sectional view of a drill in an osteotomy used with a punch-out at the gingiva.

In accordance with one or more embodiments of the present invention, a dental drill 10 is a drill bit, which when powered by a hand piece (not shown) may be used by a dentist to prepare an osteotomy 30, i.e., opening, in a mandibular or maxilla bone 32 of a patient in preparation for placement of an implanted device such as a dental implant (not shown). Dental drill 10 may be a needlepoint drill and/or a reamer for enlarging a channel made by the needlepoint drill.

Drill 10 includes a shaft 12 with cutting or reaming edges for opening a channel in bone. A tip end 14 is provided on shaft 12. A socket 16 that is operably received in the rotary handpiece is provided distal from the tip. Preferably, the socket meets one or more standards for dental rotary instruments, such as any applicable ISO standards including ISO 1797-1:1992.

To function properly, an implant will require osteotomy 30 to have a specific osteotomy depth 34 determined by the manufacturer of the implant. Drill 10 includes a plurality of bands 18 that extend peripherally around the shaft to indicate a plurality of distances 20 and 22 as measured from tip end 14. Distances 20 correspond directly to osteotomy depth 34 for a respective number of implants when the flap procedure is utilized. Distances 22 correspond to osteotomy depth 34 for a respective number of implants plus a gingival thickness, i.e., the surgical length, when the flapless procedure is utilized.

As illustrated, drill 10 includes bands 18a, 18b, and 18c associated with at least three implants requiring different osteotomy depths. Drill 10 may have one or more bands, but preferably includes at least a plurality of bands such that drill 10 may be used for a plurality of implants.

Each band 18 includes a first edge 19a and a second 19b, which is more distal from the tip than the respective first edge, formed on each side of a medial portion 19c. The medial portion preferably includes a coloration, for example, black, that designates the safe drilling depth. The coloration may be obtained from a paint, laser etching, or any other means. Each band is preferably oriented to have a radial axis perpendicular to the longitudinal axis of the shaft.

First edge 19a marks a distance 20 from the tip to the first edge that corresponds to the osteotomy depth 34 from the exposed bone, preferably the crestal bone, for the particular implant. Having exposed bone 36 by creating flaps 38a from gingiva 38, edge 19a may be used by a dentist during a flap surgery to indicate the precise osteotomy depth 34 needed. Since exposed bone 36 is visible to the dentist, the dentist can use first edge 19a to properly gauge against the bone and prepare osteotomy 30 to the required depth 34.

In accordance with one or more embodiments of the present invention, for the drill illustrated in FIG. 1, first edge 19a may indicate a length 20a, 20b, and 20c from tip end 14 and correspond to osteotomy depth 34 for the at least three implants.

When a flapless procedure is desired, a bone portion comparable to exposed bone 36 in the flap procedure is actually obstructed by the gingiva and/or the drill since only a small punch-out 38b made in gingiva 38 is prepared or when a needlepoint drill is used to drill through the mucosa. Therein, second edge 19b marks a distance 22 from tip end 14 to the second edge that corresponds to the same osteotomy depth 34, i.e., surgical length 34a, but measured from a top surface of a gingivus having a typical depth over the crestal bone for the same diameter as in the prior procedure.

Advantageously, using drill 10 configured as a needlepoint drill will prepare a succinct opening in the mucosa without damage to the tissue. Since bone typically comprises biologically irregular non-planar surfaces, drill 10 will indent the bone, i.e., drill into the bone, while indicating the proper depth 34 i.e., surgical length 34a, with accuracy in one continuous time-saving procedure.

In accordance with one or more embodiments of the present invention, for the drill illustrated in FIG. 1, second edge 19b may indicate a length 22a, 22b, and 22c from tip end 14 and correspond to a surgical length 34a, i.e., osteotomy depth 34 for the at least three implants plus typical gingival thickness.

Medial portion 19c comprises a 3 mm length between the first and second edge. Therein, dimension 20a is 8 mm, 20b is 11.5 mm, and 20c is 15 mm. Dimension 22a is 11 mm, 22b is 14.5 mm, and 22c is 18 mm. Each medial portion, 3 mm band, is used to indent the osteotomy to the selected needs. The first edge is used with flap tissue deflected procedures and the second edge is used for flapless procedures.

In accordance with one or more embodiments of the present invention, FIG. 4 is a detailed view of the drill of FIG. 1, wherein the bands are shown having a particular gradation coloration. A medial portion 19c includes a coloration that changes gradually from first edge 19a to second edge 19b in order to impart an urgency as the typical gingival thickness is reached, as for example, illustrated in FIG. 4.

While the invention has been described in conjunction with specific embodiments, it is to be understood that many alternatives, modifications, and variations will be apparent to those skilled in the art in light of the foregoing description.

What is claimed is:

1. A dental drill for making an osteotomy, the drill comprising:
a socket operably received in a hand piece;
a shaft for cutting the osteotomy, the shaft comprising a tip end;
a plurality of bands, each band comprising a first edge and a second edge, the second edge being more distal from the tip end, the first edge marking an osteotomy depth from a bone surface and the second edge marking a surgical length from a gingivus.

2. The dental drill of claim 1, wherein each band has a medial portion comprising a 3 mm length between the first and second edge.

3. The dental drill of claim 1, wherein the first edge is used for a flap osteotomy procedure.

4. The dental drill of claim 1, wherein the second edge is used for a flapless osteotomy procedure.

5. An implant dental drill associated with a plurality of implants, the drill comprising:
a shaft for cutting the osteotomy, the shaft comprising a tip end;
a band comprising a first edge and a second edge, the edges being spaced apart and referencing a single osteotomy depth for different surgical procedures.

6. The implant dental drill of claim 5, wherein the first edge and the second edge are spaced apart by distance of 3 mm.

7. The implant dental drill of claim 5, further comprising two additional bands, each of the additional bands comprising a respective first and second edge for accommodating at least three implant osteotomy depths.

8. The implant dental drill of claim 5, wherein a distance between the tip end and the first edge comprises the osteotomy depth.

9. The implant dental drill of claim 5, wherein a distance between the tip end and the second edge comprises the osteotomy depth and a gingival thickness.
